(19) United States
(12) Patent Application Publication
(10) Pub. No.: US 2004/0262105 A1
(43) Pub. Date: Dec. 30, 2004

(54) Eddy-current wheelend retarder featuring modified rotor skin effect

(76) Inventors: Zhesheng Li, Dearborn Heights, MI (US); Randy C. Stevenson, Saline, MI (US); Mahmoud Abdel-haq, Dearborn, MI (US)

Correspondence Address: VISTEON, C/O BRINKS HOFER GILSON & LIONE, PO BOX 10395, CHICAGO, IL, 60610, US

(21) Appl. No.: 10/437,343

(22) Filed: May 13, 2003

(51) Int. Cl. B60L 7/00

(52) U.S. Cl. 188/267; 188/158

(57) ABSTRACT

An automotive eddy current retarder includes a stator mounted to a frame of the vehicle, a plurality of claw-type poles disposed along an outer perimeter of the stator, and a single coil through each pole. A rotor, mechanically coupled to a wheelend of the vehicle, includes an annular ferro-magnetic body that rotates about the stator. The rotor further includes an annular conductor disposed on the radially inner surface of the ferro-magnetic body. The annular conductor, which preferably includes end rings bridged by integrally-formed, axially-extending bars whose depth dimension exceeds their width dimension, lowers the surface resistivity of the ferro-magnetic body to thereby increase the skin effects achieved at higher rotational speeds of the rotor relative to the stator, while further increasing the maximum braking torque generated by the retarder.

### FIELD OF THE INVENTION

The invention relates to braking systems for motor vehicles in which an eddy-current retarder is employed in concert with a frictional braking system to provide vehicle braking.

### BACKGROUND OF THE INVENTION

Known eddy current braking systems or “retarders” for motor vehicles typically include a rotor driven by a part of the vehicle's drivetrain, such as a vehicle's driveline axle or a stub shaft of vehicle's wheelend assembly. The rotor, which includes an armature body of a ferro-magnetic material, is disposed for rotation within a stator that is fixedly mounted to the vehicle chassis. When inductor windings on the stator are energized, eddy currents are induced in the armature body. Because the resistivity of the armature body, the eddy currents cause energy to be dissipated, thereby generating a braking force that serves to retard the rotation of the rotor and, hence, decelerate the vehicle.

Known eddy current retarders are often installed on the vehicle transmission output shaft, upstream of the differential or transfer case by which driving torque is distributed to the vehicle's wheelend assemblies. While such a placement of an eddy current retarder is effective in supplementing a vehicle's frictional duty brakes, the system cannot provide selective or independent braking of each connected wheelend assembly, as might be desired in a traction control or vehicle stability control mode. Moreover, the salient pole designs employed by known eddy current retarders may not generate a sufficient braking torque, even at top speeds, thereby requiring increased reliance upon the associated frictional brake system at such higher vehicle speeds, where the greatest amount of friction-pad-damaging heat and wear occurs.

Still further, known eddy current retarders typically generate a maximum braking torque at a maximum rotational speed. Because the armature rotates in unison with the drive shaft that is itself coupled to the wheels with a fixed differential reduction ratio, the maximum speed/maximum retarding force is rarely, if ever, achieved by the retarder.

Thus, known eddy current retarders often provide both an insufficient improvement in vehicle braking performance, an insufficient reduction in brake wear and lengthening of frictional brake life, and rarely generate a maximum braking torque.

### SUMMARY OF THE INVENTION

It is an object of the invention to provide an eddy current retarder for a motor vehicle that overcomes the above-described deficiencies of prior art eddy current retarders.

Under the invention, an eddy-current retarder adapted for use on a wheelend of a motor vehicle includes a stator adapted to be nonrotationally mounted to the vehicle frame, wherein the stator includes a plurality of claw-type poles disposed about an outer perimeter of the stator, and a common coil or inductor winding is wound through each of the poles, for example, within an annular recess itself defined by the radially-inner portion of each pole pair. The retarder further includes a rotor disposed for rotation about the stator. The rotor includes an armature that is mechanically coupled to the wheelend for rotation with the wheelend. The rotor further includes a generally annular ferro-magnetic body supported by and rotatable with the armature, such that a radially-inner surface of the rotor body is disposed in close-spaced opposition with the several pole pairs of the stator. Upon energizing the stator winding, a relative rotation of the rotor about the stator induces eddy currents between the poles of the stator and the radially-inner surface of the rotor, thereby retarding such relative rotation of rotor and stator.

Under the invention, a portion of the inner surface of the rotor body is defined by a conductor that includes a pair of end rings, disposed on either end of the rotor body, and a plurality of circumferentially-spaced, axially-extending bars. By defining a plurality of eddy current paths on the surface of the rotor body, the conductor lowers the surface resistivity of the rotor body to thereby enhance generated braking torque, while the number and dimension of the bars is selected to advantageously lower the relative speed at which the maximum braking torque is generated.

In accordance with another aspect of the invention, the cross-sectional configuration of the bars of the rotor's conductor modifies the skin effect achieved in response to eddy current generation within the rotor body, to thereby enhance the braking torque developed at relatively higher rotational speeds.

The resulting claw-pole eddy current retarder is capable of generating an increased braking torque over a wider range of vehicle speeds than known designs, thereby allowing for a reduced amount of frictional brake supplementation of the retarder's braking effect over such range of vehicle speeds, whereby the life-shortening effects of high speed frictional braking system operation can often be advantageously avoided.

Additional features, benefits, and advantages of the invention will be apparent to those skilled in the art to which the invention relates from the subsequent description of several exemplary embodiments and the appended claims, taken in conjunction with the accompanying Drawings.

### BRIEF DESCRIPTION OF THE DRAWINGS

Referring to the Drawings, wherein like reference numerals are used to designate like components within each of the several views:

FIG. 1 is a perspective view of an exemplary eddy-current retarder for a wheelend of a motor vehicle, in accordance with the invention;

FIG. 2 is a side elevation of the retarder, partially broken away to show the claw-type stator poles and encircling rotor featuring an in-cast conductor defining a portion of the rotor's inner surface;

FIG. 3 is an enlarged section of the rotor, further illustrating the conductor defining portions of the rotor body's inner surface;

FIG. 4 is a partial lateral section of the rotor, taken along line 4-4 of FIG. 3, illustrating the conductor's longitudinally-extending bars; and

FIG. 5 is a plot of braking torque versus rotor speed for the exemplary retarder for each of two different squirrel cage configurations, including an illustration of the modified skin effect that is achieved in accordance with another aspect of the invention, along with an exemplary plot of braking torque versus rotor speed for a typical prior art eddy current retarder.

### DETAILED DESCRIPTION OF THE INVENTION

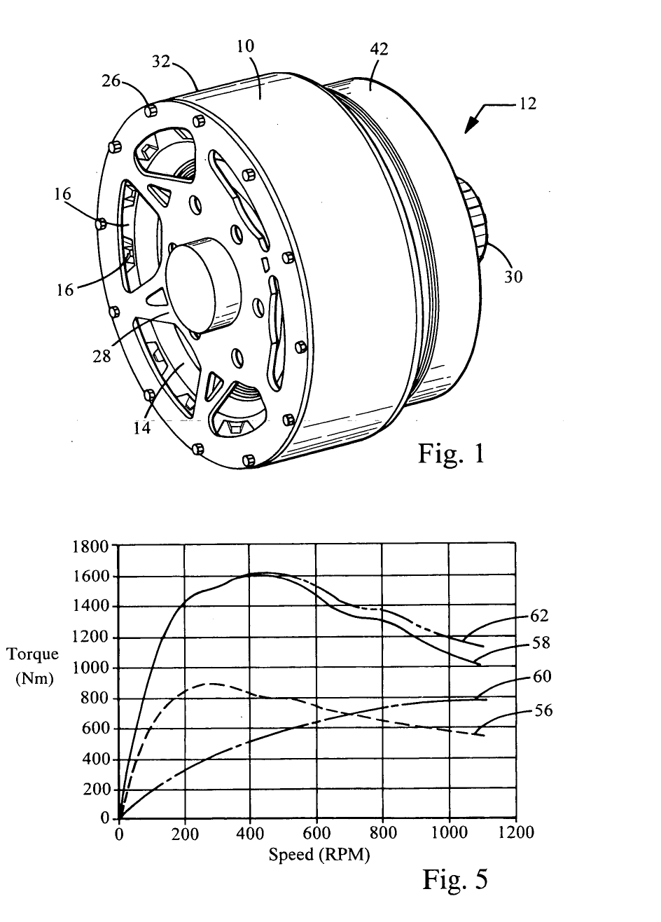

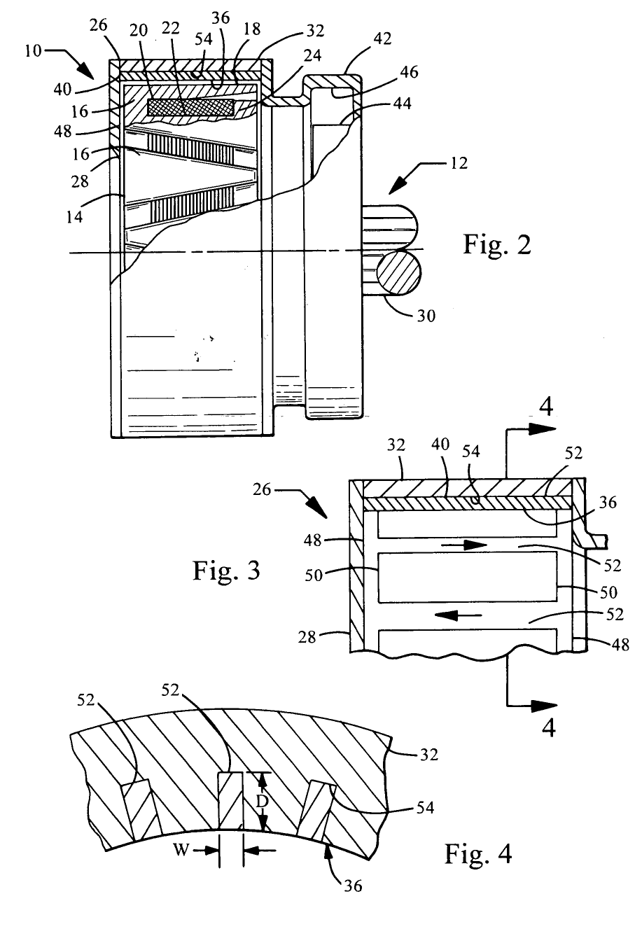

Referring to FIGS. 1 and 2, an exemplary eddy-current retarder 10 adapted for use on a vehicle wheelend 12 includes a stator 14 adapted to be nonrotationally mounted to the vehicle frame (not shown). The stator 14 includes a plurality of claw-type poles 16 disposed about an outer perimeter 18 of the stator 14. A single inductor winding or coil 20 is wound circumferentially through each of the poles 16 within an annular recess 22 defined by the radially-inner portion 24 of each pole pair 16.

While the invention contemplates any suitable pole design for the stator, in the exemplary system, a claw-pole design is employed to permit a greater number of poles 16 for a given package size, with an increased torque density. The claw-pole design advantageously uses the single large exciting coil 20 rather than the individual coils employed by salient pole designs. While the use of a single coil 20 results in a modest reduction in the flux density of the magnetic circuit, the use of the single coil 20 advantageously provides a substantial reduction of up to perhaps 75 percent or more in the impedance of the field winding. As a further benefit, the retarder's claw-pole design generates a desired field with less input power to the coil 20 than would be the case with a salient pole design.

As best seen in FIGS. 2-4, the exemplary eddy current retarder includes a rotor 26 having an armature 28 that is mechanically coupled to a wheel axle 30 of the vehicle. The rotor 26 further includes a generally annular ferro-magnetic body 32 supported by and rotatable with the armature 28 as with a plurality of radially-extending arms 34, such that a radially-inner surface 36 of the rotor body 32 is disposed in close-spaced opposition with the poles 16 of the stator 14. By way of example, the rotor body 26 is conveniently cast of 1010 steel.

In accordance with an aspect of the invention, a portion 38 of the inner surface 36 of the rotor body 32 is defined by an electrical conductor 40, by which a plurality of lower-resistivity eddy current paths are themselves defined on the rotor body's inner surface 36. FIG. 2 further shows the rotor body 32 coupled for rotation with a brake drum 42, while the vehicle frame further supports friction pads 44 that are pivotally urged into engagement with an inner surface 46 of the brake drum 42, thereby defining a frictional braking system for the vehicle's wheelend.

As seen in FIGS. 3 and 4, the rotor's conductor 40 includes a pair of end rings 48 disposed on the respective axial ends of the rotor body 32, for example, in complementary circumferentially-extending recesses 50 defined in the rotor body 32. The rotor's conductor 40 further includes a plurality of circumferentially-spaced, axially-extending bars 52 connecting the two rings 48, likewise disposed in complementary axially-extending recesses 54 defined in the rotor body 32.

By way of example only, in the exemplary embodiment, the end rings 48 and bars 52 of the rotor's conductor 40 are conveniently formed of either copper or, preferably, if a relatively-high-temperature, low-resistivity aluminum alloy that is insert-cast into the machined recesses 50,54, whereby the dimensions of the rings 48 and, particularly, the bars 52 are precisely controlled. Indeed, in accordance with another aspect of the invention, the number of bars 52 (or bar pitch), and the width dimension W of each bar 52, are preferably selected to achieve an increased maximum eddy current braking torque that peaks at a predetermined rotational speed that is substantially less than the maximum rotational speed of the rotor 26 relative to the stator 14, as illustrated by plots 56 and 58 in FIG. 5, thereby providing more useful eddy current braking torque than prior art designs featuring a relatively-lower maximum eddy current braking torque that peaks at maximum rotational speed, as illustrated by plot 60 in FIG. 5. By way of illustration only, the second plot 58 demonstrates an increased and shifted maximum eddy current braking torque achieved for a given stator configuration, relative to the first plot 56, as the number of bars 52 is increased by 33%, and the width dimension W of each bar 52 is reduced by 25% (the relative cross-sectional geometry changing from a 2:3 to a 1.5:4).

Subsequent to insert casting, the rotor's inner surface 36 is machined to achieve a desired gap between the rotor's inner surface 36 and the outer periphery of the stator poles 16.

Upon energizing the stator winding 20, an electromagnet is created and a magnetic flux field is generated between the stator poles 16 and the rotor body's opposed, inner surface 36. Eddy currents are generated within the rotor body 32 and the conductor's bars 52 upon rotation of the rotor 26 relative to the energized poles 16 of the stator 14. The creation of the magnetic flux field and generation of eddy currents produces Lorenz forces that act to retard the rotation of the rotor. The energy is then dissipated as heat from the rotor 26, as through use of cooling fins (not shown).

In accordance with an aspect of the invention, the rotor's conductor 40 modifies the skin effect achieved in response to eddy current generation within the rotor body 32. Specifically, the skin effect operates to increase eddy current resistance at the inner surface 36 of the rotor body 32 at higher frequencies, i.e., higher relative rotational speed of the rotor 26. The amount of the skin effect achieved with the exemplary retarder 10 at such high frequencies can be increased by increasing the depth dimension D of the conductor's bars 52. Thus, further illustrated in as illustrated by the phantom extension 62 to plot 58 of FIG. 5, the braking torque developed at relatively higher rotational speeds is enhanced. By way of example, in one constructed embodiment generating the first plot 56 of FIG. 5, the cross-sectional configuration of each bar 52 is characterized by a ratio of 2:3, maximum width to maximum depth. In another constructed embodiment generating the second plot 58 of FIG. 5, the generally-rectangular cross-sectional configuration of each bar 52 is characterized by a ratio of about 1.5:4, maximum width to maximum depth.

While the bars 52 are illustrated in FIG. 4 as having a generally-rectangular configuration, the invention contemplates other cross-sectional configurations in which each bar's depth dimension D exceeds the bar's width dimension W and, preferably, significantly exceeds the bar's width dimension W.

In accordance with another aspect of the invention, a pulse-width modulation (PWM) excitation signal is preferably used to power the winding 20 to thereby achieve a relatively higher response rate. In this matter, the eddy-current retarder 10 develops sufficient braking torque to significantly supplement the wheelend assembly's frictional duty brakes. The exciting field is preferably controlled to provide a blending of braking function between the wheelend's frictional brake system and eddy current retarder 10. It will be appreciated, however, that during certain operating modes, such as a traction control or vehicle stability control mode, the wheelend's eddy current retarder maybe used exclusively in order to provide a more flexible braking response while further reducing brake wear.

While an exemplary eddy current retarder is described above, it will be appreciated that the invention is susceptible to modification, variation and change without departing from the proper scope and fair meaning of the subjoined claims. For example, while the conductor of the exemplary retarder is conveniently insert-cast into the complementary recesses defined in the rotor body, it will be appreciated that the conductor can be integrated with the rotor body in other ways, for example, as by brazing.

Further, while the rotor of the exemplary retarder rotates about the outer periphery of the stator, it will be appreciated that the invention is equally applicable to retarder geometries in which the rotor is disposed within the stator for relative rotation.

Further, it will be appreciated that the eddy current retarder may be capable of operating at one or more levels of retard, ranging from an inactive state where little or no retarding torque is applied to the wheelend assembly, progressively to a maximum state of applying retarding torque to the wheelend assembly shaft. Alternatively, with the eddy current retarder may be capable of providing a continuously variable level of retarding torque. The invention will also be seen to contemplate use of such familiar retarder components as a plurality of cooling fins or vanes about the rotor, preferably configured to draw air into rotor and through the retarder during operation to remove heat dissipated from the armature when the winding is energized.

We claim:

1. An eddy current retarder for selectively applying a braking torque to a wheelend supported on a vehicle frame for rotation about an axis, the retarder comprising:
a stator adapted to be supported on the vehicle frame, the stator including a plurality of poles disposed about a perimeter of the stator, and at least one coil operative to form an electromagnet with an adjacent pair of poles when the at least one coil is energized; and
a rotor adapted to be coupled for rotation with the vehicle wheelend, the rotor including an annular rotor body defining an annular inner surface in close-spaced opposition with the poles of the stator, the rotor further including a conductor defining a portion of the inner surface, the conductor having a pair of axially-spaced annular rings and a plurality of circumferentially-spaced bars extending between the annular rings, each bar having a maximum depth dimension and a width depth dimension relative to the inner surface, the maximum depth dimension being greater than the maximum width dimension,
wherein the rotor rotates about the stator to induce eddy currents between the poles of the stator and the inner surface of the rotor body, the eddy currents resisting relative rotation of the rotor and the stator.

2. The retarder of claim 1, wherein each bar defines a generally rectangular shape in cross-section.

3. The retarder of claim 1, wherein the maximum depth dimension is at least about 150% of the maximum width dimension.

4. The retarder of claim 1, wherein the maximum depth dimension is at least about 200% of the maximum width dimension.

5. The retarder of claim 1, wherein the number of bars is selected to generate a maximum braking torque at a relative rotational speed substantially less than a maximum relative rotational speed.

6. The retarder of claim 1, wherein the rotor body includes a plurality of recesses defined in the inner surface, and wherein the conductor is formed by insert casting of a conductive material into the recesses of the rotor body.

7. An eddy current retarder for selectively applying a braking torque to a wheelend supported on a vehicle frame for rotation about an axis, the retarder comprising:
a generally-annular stator adapted to be supported on the vehicle frame, the stator including a plurality of claw poles disposed about an outer perimeter of the stator, the poles defining an annular recess, and a coil wound about the annular recess such that an adjacent pair of poles form an electromagnet when the coil is energized; and
a generally-annular rotor adapted to be coupled for rotation with the vehicle wheelend, the rotor including an annular body formed of a ferro-magnetic material and defining a radially-inner surface of the rotor in close-spaced opposition with the poles of the stator, the rotor further including a conductor defining a portion of the radially-inner surface, the conductor having a pair of axially-spaced annular rings and a plurality of circumferentially-spaced bars interconnecting the annular rings, each bar having a maximum depth dimension and a width depth dimension relative to the radially-inner surface, the maximum depth dimension being greater than about 150% of the maximum width dimension,
wherein the rotor rotates about the stator to induce eddy currents between the poles of the stator and the radially-inner surface of the rotor body, the eddy currents resisting relative rotation of the rotor about the stator.

8. The retarder of claim 7, wherein each bar defines a generally rectangular shape in cross-section.

9. The retarder of claim 7, wherein the maximum depth dimension is at least about 200% of the maximum width dimension.

10. The retarder of claim 7, wherein the number of bars is selected to generate a maximum braking torque at a relative rotational speed substantially less than a maximum relative rotational speed.

11. The retarder of claim 7, wherein the rotor body includes a plurality of recesses defined in the inner surface, and wherein the conductor is formed by insert casting of a conductive material into the recesses of the rotor body.
